(19) United States
(12) Patent Application Publication
(10) Pub. No.: US 2012/0072988 A1
(43) Pub. Date: Mar. 22, 2012

(54) DETECTION OF GLOBAL METAMORPHIC MALWARE VARIANTS USING CONTROL AND DATA FLOW ANALYSIS

(75) Inventor: Hira Agrawal, Bridgewater, NJ (US)

(73) Assignee: TELCORDIA TECHNOLOGIES, INC., Piscataway, NJ (US)

(21) Appl. No.: 13/072,114

(22) Filed: Mar. 25, 2011

Related U.S. Application Data
(60) Provisional application No. 61/317,777, filed on Mar. 26, 2010.

(51) Int. Cl. G06F 12/14

(52) U.S. Cl. 726/24

(57) ABSTRACT

Malware feature extraction derives semantic summaries of executable malware using global, inter-procedural program analysis techniques. A combination of global, inter-procedural program analysis techniques constructs semantic summaries of malware which automatically detect and discard any noise introduced by transformations and capture the essence of the underlying computations in a succinct form. This is achieved in two ways. First, global control flow analysis techniques are used to derive a high level representation of malware code that, for instance, removes the effects of subroutine calls. Second, global data flow analysis techniques are employed to detect and remove all spurious elements of malware that do not contribute towards its underlying computation, thereby preventing the resulting summaries from being “corrupted” with unnecessary, extraneous elements.

### CROSS-REFERENCE TO RELATED APPLICATIONS

This application claims the benefit of U.S. Provisional Application No. 61/317,777, filed on Mar. 26, 2010 which is incorporated by reference herein in its entirety.

### FIELD OF THE INVENTION

The present invention relates generally to cyber security and specifically relates to deriving malware signatures of executable malware using global, inter-scale program analysis techniques that are resistant to global, large-scale malware transformations which can produce variants with drastically different call graphs and equally dissimilar flow graphs.

### BACKGROUND OF THE INVENTION

The present invention is a novel technique to derive high level signatures of malware, such as computer viruses and worms that will enable many more variants of such malware to be detected than what are possible today using existing techniques. The high level signatures capture semantic malware summaries that are not perturbed by global, large-scale, automated transformations, which can produce malware variants that differ drastically from one another. These transformations are made possible by a new breed of metamorphic malware engines, which take one malware sample as input and use automated program diversification techniques to produce an exponentially large number of variants with completely different call graphs and flow graphs. The transformations include, for instance, randomly splitting code blocks into functions, merging existing functions into parent functions, and inserting new, irrelevant function calls, complete with their definitions which may even be recursive. All of these transformations can be applied repeatedly and recursively, but they are applied in a manner that does not affect the overall semantics of the code involved. The present invention abstracts away all of these syntactic differences and captures their common, semantic content into concise signatures, which can be used to match future, as yet unknown variants of the same malware.

Prior solutions rely on syntactic signatures, such as code checksums and presence of specific byte sequences, to locate and isolate malware from genuine, legitimate code. These methods are easily evaded by polymorphic and metamorphic malware that can automatically and repeatedly morph themselves, so they can no longer be caught using prior, existing signatures. Some prior solutions also use flow graphs or call graphs of malware as their signatures, but such signatures are also easily defeated by performing global malware transformations which can alter both the call graph and the flow graphs of individual functions within that malware. The present invention, on the contrary, abstracts away all of these syntactic differences and captures their common, semantic content into concise signatures, which can be used to match future, unknown variants of the same malware.

Many new techniques have been developed for constructing higher level semantic signatures that do not require exact matches for detecting malware instances. They can, therefore, match multiple polymorphic variants of the same malware. These techniques, however, can address only a subset of malware variants. Many of them, for example, address only variants that are created using relatively simple techniques like substituting one register for another in a block of assembly instructions, replacing an operation such as “add” with another equivalent operation such as “subtract” while negating its operand, reordering certain instructions within a block that do not interfere with one another, and inserting redundant instructions that do not affect the outcome of the computation involved, among others. Some of these techniques also analyze higher-level representations of code such as flow graphs of functions rather than raw bytes representing that code. They can, therefore, accommodate small, local polymorphic changes in malware code as long as they do not significantly alter the higher, overall structure of the flow graph involved. They will, however, fail to spot variants that make significant, but otherwise benign, changes to the branching structures of that flow graph. Other techniques take a more global view. Instead of examining flow graphs of individual functions, they analyze their high level calling structure. They will, therefore, catch all variants that belong to the same malware family as long as they do not drastically alter the shape of the call graph involved. Creating variants with significantly different call graphs, however, is fairly easy. The call graph based techniques too, therefore, will fail to detect large sets of malware variants that are generated automatically in this way. The inventive approach based on deriving semantic summaries of malware, on the contrary, is resistant to such global, large scale transformations.

Prior solutions rely either on detecting syntactic differences among malware variants or comparing their control structures, which can be easily defeated by modifying those structures without modifying the underlying semantics. They may also be defeated by introducing a lot of spurious code in those variants. Using the present invention it is possible to remove all spurious code using data flow analysis and, furthermore, drastically simplify the resulting structures using global super-block analysis techniques, which result in signatures that are easily comparable. This approach required a novel combination of existing techniques with super block dominator analysis techniques, which is described in H. Agrawal. Dominators, Super Blocks, and Program Coverage. ACM Symposium on Principles of Programming Languages, 1994, pp. 25-34 and in H. Agrawal. Efficient Coverage Testing Using Global Dominator Graphs, ACM Workshop on Program Analysis Tools and Engineering, 1999, pp. 11-20.

### SUMMARY OF THE INVENTION

Prior solutions, as mentioned above, rely on syntactic signatures, such as code checksums and presence of specific byte sequences, to locate and isolate malware from genuine, legitimate code. These methods are easily evaded by polymorphic and metamorphic malware that can automatically and repeatedly morph themselves, so they can no longer be caught using prior, existing signatures. Some prior solutions also use flow graphs or call graphs of malware as their signatures, but such signatures are also easily defeated by performing global malware transformations which can alter both the call graph and the flow graphs of individual functions within that malware. The present invention, on the contrary, abstracts away all of these syntactic differences and captures their common, semantic content into concise signatures, which can be used to match future, unknown variants of the same malware.

Additionally, prior solutions rely either on detecting syntactic differences among malware variants or comparing their control structures, which can be easily defeated by modifying those structures without modifying the underlying semantics. They may also be defeated by introducing a lot of spurious code in those variants. The present invention can remove all spurious code using data flow analysis and, furthermore, drastically simplify the resulting structures using global super-block analysis techniques, which result in signatures that are easily comparable. This approach requires a novel combination of existing techniques with super block dominator analysis techniques.

The present invention is a technique to derive high level, semantic signatures of malware such as computer viruses, worms, Trojans, backdoors, and logic bombs, among others. These signatures may be used to detect not only the malware from which those signatures were extracted, but also detect their variants, which may have been generated automatically using metamorphic transformation engines. Without such semantic signatures, malware detection tools will need to constantly update their signature databases with signatures of new variants, which is impractical given that a malware instance may have an exponentially large number of variants.

The present invention has the advantage that one semantic signature can be used to match an exponentially large number of malware variants that belong the same family. As these variants can be generated automatically with the help of a metamorphic variant generation engine, manually generating a signature for each such variant is impractical. Storing a separate signature for each variant is also infeasible because a malware instance can have an exponentially large number of variants. Semantic signatures also enable zero-day malware attacks, because new variants do not require the corresponding signatures to be added to the signature database.

The present invention is a novel form of malware feature extraction that derives semantic summaries of executable malware using global, inter-procedural program analysis techniques. These summaries are not perturbed by global, large-scale malware transformations, which can produce variants with drastically different call graphs and equally dissimilar flow graphs. Such transformations are enabled by a new breed of metamorphic malware engines, which take one malware sample as input and use automated program diversification techniques to produce, on demand, an exponentially large number of variants with completely different call graphs and flow graphs. The transformations include, for instance, randomly splitting code blocks into functions, merging existing functions into parent functions, and inserting new, irrelevant function calls, complete with their spurious definitions which may even be recursive. All of these transformations can be applied repeatedly and recursively, but they are applied in a manner that does not affect the overall semantics of the code involved.

The invention also has application to detect/classify malware in any form of software: source code, binary code, byte code, scripts, etc. In addition, there are applications besides malware detection/classification, for example, it also can be used to detect plagiarized software.

The present invention will be best understood when the following description is read in conjunction with the accompanying drawings.

### BRIEF DESCRIPTION OF THE DRAWINGS

FIG. 1 is a simple example of an algorithm used to illustrate generation of high level semantic summaries that are robust in the face of global transformations.

FIG. 2 is a variant of the code in FIG. 1 depicting global transformations where code fragments may be pushed into subroutines or pulled out of them.

FIG. 3 is a flow graph (top) and a call graph (bottom) of the example program in FIG. 1.

FIG. 4 is an inter-procedural flow graph (top) and a call graph (bottom) of the variant in FIG. 2.

FIG. 5 is a super-block dominator tree of the flow graph in FIG. 3.

FIG. 6 is a program dependence graph of the example in FIG. 1.

FIG. 7 is a projection of the super-block dominator tree in FIG. 5 over nodes in program slice shown as shaded nodes in FIG. 6.

### DETAILED DESCRIPTION

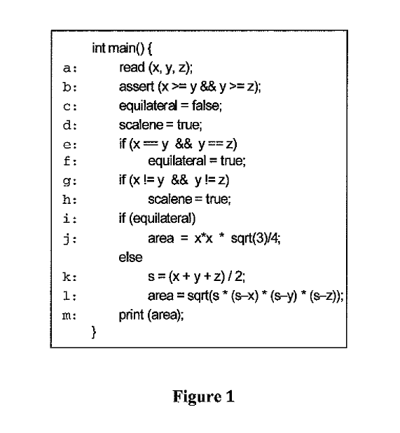

Referring now to the figures and in particular refer to the simple example in FIG. 1. For brevity of presentation, the code is shown in C. The technique of the present invention applies equally well to malware code available as disassembled binary or that written using a scripting language.

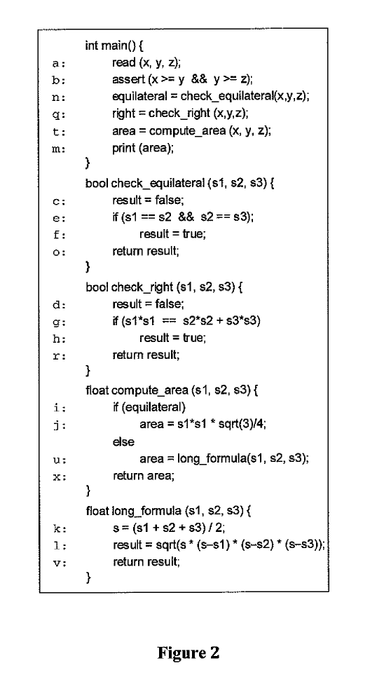

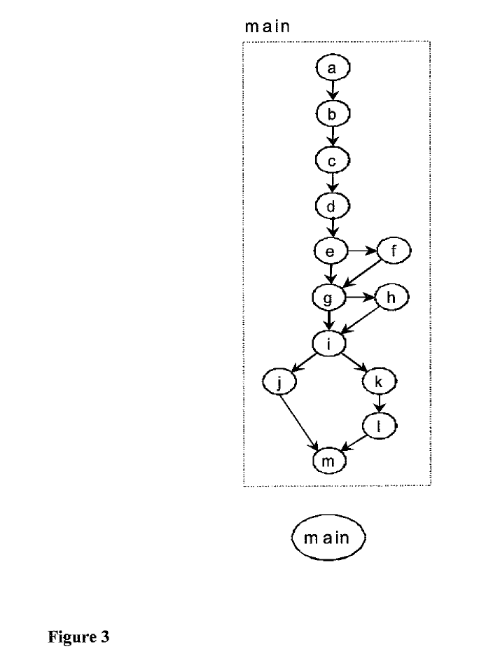

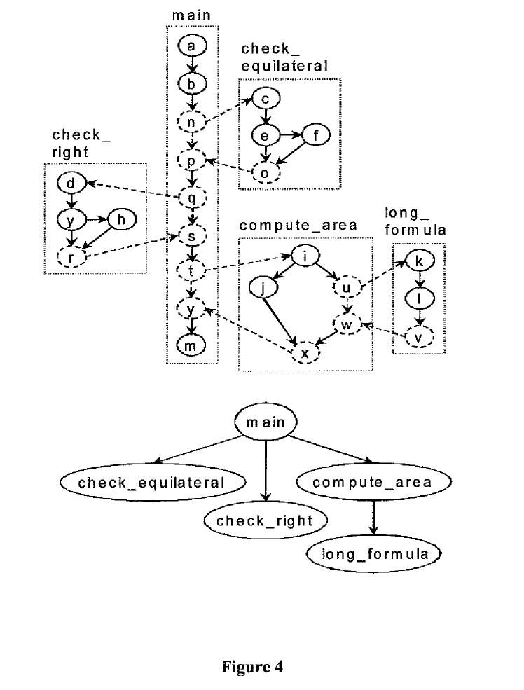

The example code in FIG. 1 reads the lengths of the three sides of a triangle, determines what type of triangle it is, and uses that information to compute its area and prints the same. FIG. 2, shows a variant of this program where some of the code has been pushed into subroutines, and the code that determines if the given triangle is a scalene triangle has been replaced with a check for a right triangle. In general, the code in FIG. 2 is an example of global transformation where code fragments may be pushed into subroutines or pulled out of them. Such transformations may be carried out in an automated manner and may be applied recursively. FIGS. 3 and 4 depict both flow graphs (in the top) and call graphs (in the bottom) of these two examples, respectively. Dashed nodes and edges in the flow graph represent dummy nodes and edges introduced to model transfer of control between subroutines. Note that the two flow graphs differ drastically from one another, and the two call graphs are, equally dissimilar, even though their underlying programs are semantically equivalent. Techniques that rely on comparison of flow graphs and call graphs, therefore, will fail to conclude that the two programs are variants of one another.

The present invention uses a combination of global, inter-procedural program analysis techniques to construct semantic summaries of malware which automatically detect and discard any noise introduced by such transformations and capture the essence of the underlying computations in a succinct form. This is achieved in two ways. First, the invention uses global control flow analysis techniques to derive a high level representation of malware code that, for instance, removes the effects of subroutine calls. Second, the invention employs global data flow analysis techniques to detect and remove all spurious elements of malware that do not contribute towards its underlying computation, thereby preventing the resulting summaries from being “corrupted” with unnecessary, extraneous elements.

The control flow analysis technique partitions all statements in a given malware code into “super blocks” which have the property that any execution path through the program that includes one statement in a partition necessarily includes all other statements in the same partition, although they need not be executed contiguously, one after another. Furthermore, the control flow analysis technique arranges these partitions into a hierarchical, rooted tree structure, called super-block dominator tree, which has the additional property that any malware execution path that executes one super-block also executes all of its ancestor super-blocks in that tree.

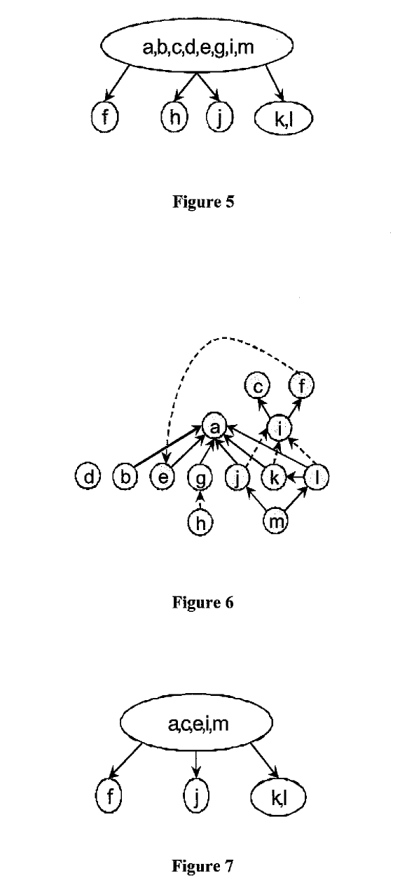

FIG. 5 shows the super-block dominator tree of the flow graph in FIG. 1. If the corresponding tree for the flow graph in FIG. 2 is constructed and all dummy call site, call return, and function exit nodes from the resulting tree are projected, the result is the same tree as that shown in FIG. 5, with one difference: the check for a scalene triangle (statement “g”) will be replaced with the check for a right triangle (statement “y”) in the root node. Note, however, that neither of these checks contribute towards calculation of area in their respective variants, as that calculation is based solely on whether the triangle is determined to be an equilateral triangle or not. In other words, these checks, as well as the statements that are executed based on the outcome of these checks, are completely spurious, and their inclusion in the resulting summaries makes them “noisy” and, therefore, susceptible to errors. To overcome this problem, global, inter-procedural data flow analysis of malware is also performed and the corresponding program slice is constructed from its program dependence graph, and that slice is used to filter out all spurious, useless statements from its super-block dominator tree.

FIG. 6 shows the program dependence graph of the example in FIG. 1. Solid lines indicate data dependencies, and dashed lines denote control dependencies. Shaded nodes indicate the program slice, i.e., program statements that contribute towards its underlying computation. The graph consists of all nodes that are reachable from all of its “output” statements that have an “external” program effect. The graph captures data flow dependencies, depicted as solid edges, among statements that rely on the value of a variable and the statements that supply that value. It also captures control dependencies, shown as dashed edges, between statements and the conditional statements that guard their execution. The node labeled “m” in that figure denotes an “output” node (the statement that prints the result of the area computation, in this case), and all nodes that are reachable from that node by following one or more edges, shown as shaded nodes, represent the corresponding program slice. In the case of a malware, an output node comprises, for example, of a statement that makes an illegitimate system call or one that performs an unauthorized external communication, among others.

Note that, in the above example, the statements involved in determining if the given triangle is a scalene triangle, i.e., statements “d”, g”, and “h”, do not belong to the program slice, as they do not have an effect on the value of area being computed. The assert statement at node “b” is excluded from the program slice for the same reason. If a variant removed any of these statements from the code, or replaced them with other spurious statements, as was done in FIG. 2 where a check for a scalene triangle was replaced with a check for a right triangle, the resulting program slice will still match that of the original program. Similarly, if a variant changed the order of the statements that are used to classify the given triangle as being an equilateral, scalene, or a right triangle, or it added new statements that further classified it as an isosceles triangle, it will still match that summary, because it abstracts away all statements that have no bearing on the underlying computation.

The program dependence graphs from which program slices are determined, however, are often cyclic, although the graph in FIG. 6 is not, as the corresponding program in FIG. 1 does not contain any loops. Note that determining whether a given malware represents a variant of a previously known malware involves computing the “distance” between its summary and the summaries of previously known malware. Computing distances between two un-rooted, cyclic graphs, however, is a computationally hard problem. This problem can be greatly simplified if the graphs involved were rooted trees. The super-block dominator tree representation discussed earlier fulfills this requirement. But that structure preserves all spurious statements in the analyzed code, which the program slice eliminates. Accordingly, the two representations are combined by projecting the super-block dominator tree in FIG. 5 over only those statements that are included in the program slice indicated as shaded nodes in FIG. 6. FIG. 7 shows the corresponding super-block dominator tree after all unshaded nodes in FIG. 6, representing “noise”, have been projected out from the super-block dominator tree in FIG. 5. This tree represents the high level semantic summary of the example in FIG. 1, and it has all of the desired properties in a semantic summary:

The summary abstracts away relative ordering among statements that are always executed together, though not necessarily consecutively.

The summary abstracts away spurious statements that do not affect the outcome of the program.

The summary withstands large scale, recursive transformations which involve moving code fragments into and out of functions.

The summary works even in presence of recursive function calls.

The summary is relatively easy to compare with summaries derived from other malware.

To illustrate the robustness of this semantic summary against global transformations, compute the program slice of the variant in FIG. 2, using its system dependence graph, which consists of the set of program dependence graphs of all of its subroutines, linked by additional nodes and edges that represent parameter passing among subroutines and edges that summarize dependencies among those parameters. The corresponding program slice is then determined using a context-sensitive inter-procedural graph reachability algorithm starting from the output nodes. The system dependence graph of the example in FIG. 2 is omitted for brevity, but note that the resulting program slice contains exactly the same nodes as the shaded nodes in FIG. 6. This is not surprising as the variant in FIG. 2 performs exactly the same computation as the code in FIG. 1. The only thing that has changed is some of the code has been split into separate subroutines, thereby making the control flow more complex, and some spurious statements have been replaced by different set of spurious statements. Projecting out all non program slice statements out of its super-block dominator tree yields exactly the same tree as that shown in FIG. 7.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions stored in a computer or machine usable or readable storage medium or device, which causes the computer or machine to perform the steps of the method when executed on the computer, processor, and/or machine. A computer readable storage medium or device may include any tangible device that can store a computer code or instruction that can be read and executed by a computer or a machine. Examples of computer readable storage medium or device may include, but are not limited to, hard disk, diskette, memory devices such as random access memory (RAM), read-only memory (ROM), optical storage device, and other recording or storage media.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

While there has been described and illustrated a method for deriving malware signatures that are resistant to metamorphic transformations thereby enabling the detection of more malware variants for cryptic security, it will be apparent to those skilled in the art that variations and modifications are possible without deviating form the broad principles and teachings of the present invention which shall be limited solely by the scope of the claims appended hereto.

What is claimed is:

1. A method of deriving malware signatures comprising:
applying global control flow analysis to code containing malware to provide a high level representation of malware code;
applying global data flow analysis to code containing malware to detect and remove spurious elements of malware to provide malware-free code; and
combining the high level representation and malware-free code outputs.

2. The method as set forth in claim 1, wherein said combining comprises projecting the representation over the malware-free code thereby creating a high level semantic summary.

3. The method as set forth claim 1, wherein said control flow analysis partitions statements in malware code into super blocks.

4. The method as set forth in claim 1, further comprising arranging said partitions into a super block dominator tree

5. The method as set forth in claim 1, wherein said data flow analysis creates a program slice from a program dependence graph.
